(19) United States
(12) Patent Application Publication
(10) Pub. No.: US 2011/0119071 A1
(43) Pub. Date: May 19, 2011

(54) PRICE SENSITIVITY SCORES

(75) Inventors: Robert L. Phillips, Palo Alto, CA (US); Robin L. Raffard, Menlo Park, CA (US); Frank Rohde, San Francisco, CA (US)

(73) Assignee: NOMIS SOLUTIONS, INC., San Bruno, CA (US)

(21) Appl. No.: 12/941,610

(22) Filed: Nov. 8, 2010

Related U.S. Application Data
(60) Provisional application No. 61/281,164, filed on Nov. 13, 2009.

(51) Int. Cl. G06Q 99/00

(52) U.S. Cl. 705/1.1

(57) ABSTRACT

A price sensitivity score is calculated for a prospect by obtaining data associated with a prospect. A scoring function is determined (which is a function of one or more scoreable variables) based at least in part on training data set. A price sensitivity score is calculated by evaluating the scoring function using the data associated with the prospect.

### CROSS REFERENCE TO OTHER APPLICATIONS

This application claims priority to U.S. Provisional Patent Application No. 61/281,164 (Attorney Docket No NOMIP003+) entitled PRICE SENSITIVITY SCORES FOR APPLICANTS filed Nov. 13, 2009 which is incorporated herein by reference for all purposes.

### BACKGROUND OF THE INVENTION

For certain goods and services, the price of the good or service varies from customer to customer (sometimes referred to as a prospect). For example, one person might be offered one interest rate on a 5 year car loan of $20,000 but another person might be offered the same loan at a higher or lower interest rate depending upon a variety of factors. Some existing pricing techniques use credit scores (such as a FICO score) to calculate a price. It would be desirable to develop new techniques that can be used in calculating prices. It would also be useful if such techniques had other applications, for example to enable better forecasting accuracy and/or to increase a take up rate for the provider of the good or service. This may enable the provider to operate more efficiently (e.g., by reducing man hours spent on sales/marketing efforts) by better identifying those prospects who will actually take up an offer.

### BRIEF DESCRIPTION OF THE DRAWINGS

Various embodiments of the invention are disclosed in the following detailed description and the accompanying drawings.

FIG. 1 is a system diagram showing an embodiment of a system in which price sensitivity scores are calculated and used.

FIG. 2 is a flowchart illustrating an embodiment of a process for calculating a price sensitivity score.

FIG. 3 is a flowchart illustrating an embodiment of a process for determining a price sensitivity function which is a function of one or more scoreable variables.

FIG. 4 is a diagram showing an embodiment of a training data set.

FIG. 5A is a flowchart illustrating an embodiment of a process for a kernel technique.

FIG. 5B is a diagram showing an embodiment of a training data set after a raw price sensitivity function (which is a function of both scoreable and non-scoreable variables) is determined in a first step of a kernel technique.

FIG. 5C is a diagram showing an embodiment of a training data set after the kernel technique has been completed.

FIG. 6 is a flowchart illustrating an embodiment of a process in which a decomposition technique is performed.

FIG. 7A is a flowchart illustrating an embodiment of a process for performing a residual technique.

FIG. 7B is a diagram showing an embodiment of training data set after a take up probability function is selected and residuals are generated in a residual technique.

FIG. 7C is a diagram showing an embodiment of a data set after a best incremental take up probability function is determined in a residual technique.

FIG. 7D is a diagram showing an embodiment of a data set after a scoring function is determined in a residual technique.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

What is described herein is a technique for calculating price sensitivity scores. A price sensitivity score is a quantified (e.g., numeric) representation or estimate of how price sensitive a particular prospect is. Someone who is less price sensitive will (for example) continue to “take up” (i.e., buy or otherwise acquire) an offer for a good or service even if the price increases significantly. In contrast, a more price sensitive person will start refusing the good or service after a smaller increase in price. The technique described herein calculates price sensitivity score.

In some embodiments, a price sensitivity score (the calculation and usage of which is described herein) is an estimation of a person's price sensitivity in general and is not necessarily that person's price sensitivity with respect to a specific good or service at a specific price (e.g., his or her sensitivity to the price of car loans specifically or consumer electronics specifically). Rather, a price sensitivity score (at least in such embodiments) is a general representative of overall sensitivity to price with no specific product in mind or (alternatively) over a variety of (hypothetical) products.

In some embodiments, a price sensitivity score is a representative or estimate of which price sensitivity “bin” a prospect falls into. For example, suppose price sensitivity scores ranged from 1-10, where people having a score of 10 are the most price sensitive. A score of 1 may correspond to being in the lowest price sensitivity bin of all people (e.g., these people are the bottom 10% of least price sensitive people), the people with a score of 2 would fall in the next bin (e.g., those people would be the next least price sensitive people), etc.

In various embodiments, a price sensitivity score takes a variety of forms. In some embodiments, a price sensitivity score is an integer number. In some embodiments, a price sensitivity score may be a positive or negative value (e.g., a 0 may represent someone with average or typical price sensitivity). In some embodiments, a high price sensitivity score indicates the associated person is more price sensitive. In other embodiments, a low price sensitivity score indicates the associated person is more price sensitive.

In some embodiments, the relationship between price sensitivity and score is linear. For example, a prospect with a score of 80 is twice as price sensitive as a person with a score of 40. In some embodiments, price sensitivity scores are geometric (e.g., exponential), such that a difference of Δ between two scores corresponds to a difference of factor m between the two price sensitivities. Thus if Δ=10 and m=2, a difference in scores of 10 would correspond to a doubling of price sensitivity. A score of 90 would indicate a prospect who is twice as price sensitive as one with a score of 80. In some embodiments, price sensitivity scores simply order prospects in order of price-sensitivity without any other relationship among the scores.

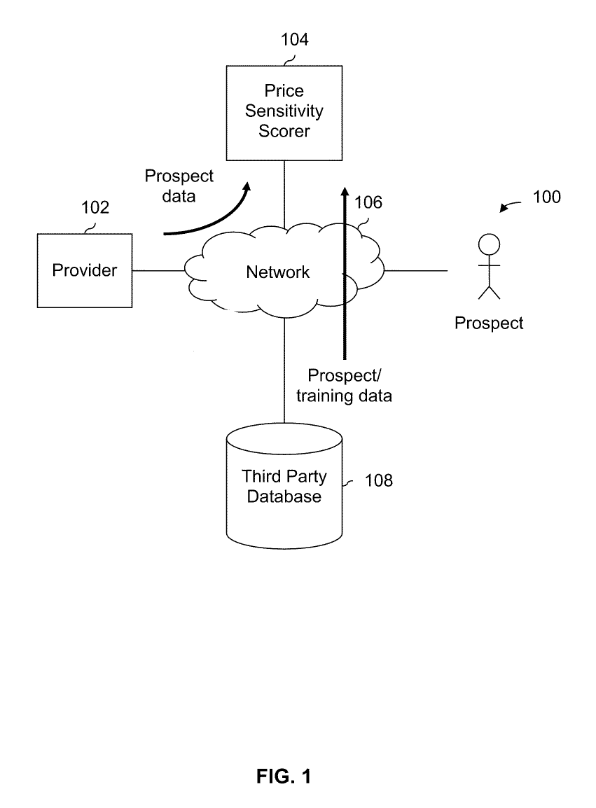

FIG. 1 is a system diagram showing an embodiment of a system in which price sensitivity scores are calculated and used. In the example shown, prospect 100 is a prospective buyer of a good or service which is offered for sale by provider 102. Prospect 100 may communicate with or contact provider 102 in a variety of channels. For example, prospect 100 may use an Internet browser application (e.g., Microsoft Internet Explorer or Mozilla Firefox) to access the website of provider 102 via network 106 to complete an application or in general communicate with provider 102. In some embodiments (not shown), prospect 100 goes into a store or office of provider 102 and fills out a paper application and mails the completed application to a processing center or gives the completed application to an in-store or in-office representative for processing.

In various embodiments, provider 102 provides a variety of goods and/or services. In one example, prospect 100 wants to open a bank account or a certificate of deposit (CD) and provider 102 is a bank or other financial institution. In some cases, provider 102 is primarily or strictly an online entity and in other cases provider 102 has a “bricks and mortar” presence (e.g., in the form of stores or offices which the prospect can visit). In other embodiments, provider 102 is a bank and prospect 100 wants a car loan, credit card, (home equity) line of credit, mortgage, etc. In some other embodiments, provider 102 is an insurance company, a credit card company, or a content or communications service provider (e.g., (cellular) telephone, Internet service provider, cable, satellite, etc.).

Price sensitivity scorer 104 calculates a price sensitivity score for prospect 100 using data associated with prospect 100. The data associated with the prospect is obtained from provider 102 and/or from third party database 108 via network 106. It is not necessary to have prospect data from both sources in order to calculate a price sensitivity score. As an example of prospect data from provider 102, prospect 100 may have provided some information to provider 102 during an application process. Some examples of such information include the prospect's name, address, birth date, age, driver's license number, or social security number (or some portion thereof). Another example of prospect data from provider 102 is if the prospect is known to provider 102. For example, provider 102 may be a bank and the prospect (e.g., currently applying for a mortgage) has had a bank account or credit card with the bank for a number of years. Information about the bank account or credit card is provided to price sensitivity scorer 104 in some embodiments. As an example of prospect data from third party database 108, third party database 108 may be a credit bureau (such as TransUnion, Equifax or Experian) and the prospect data may include information about credit history, previous or current accounts, past due information, etc. Some examples of data are described in further detail below.

Price sensitivity scorer 104 calculates a price sensitivity score for prospect 100 and returns it to provider 102, for example by entering data associated with the prospect into a scoring function which outputs a score. In some embodiments, provider 102 uses the price sensitivity score to calculate or adjust a price for prospect 100. For example, a less price sensitive prospect may be offered a (slightly) higher price or a price at the higher end of a range of prices being considered for that prospect. In some embodiments, a price calculated based on a price sensitivity score is a rate, such as an interest rate for a mortgage, loan, credit card, line of credit, etc. In some embodiments, a price calculated based on a price sensitivity score is in units of some currency (e.g., in US dollars, Canadian dollars, British pounds, etc.). In some embodiments, provider 102 uses one or more other pieces of additional information in calculating a price. For example, provider 102 may use both a price sensitivity score and a credit score (e.g., a FICO score) in calculating a price. In one example, a nominal or initial price is first calculated using a credit score and the price sensitivity score is used to adjust the nominal/initial price (e.g., adjust it by [0,Δ] or [−Δ/2,Δ/2]).

A number of benefits arise from calculating and using a price sensitivity score. In one example, provider 102 is more able to accurately tailor offers of goods or services to prospects. For instance, provider 102 may offer higher prices and higher services to low price sensitive customers; whereas it may offer lower prices and lower services to high price sensitive customers. By so doing, provider 102 may be able to match each offer with customer preferences, and therefore increase customer satisfaction. In a second example, provider 102 may use a price sensitivity score to increase take up rate (e.g., percentage of offers which are accepted) and/or profit, in application of price optimization theory. In a third example, the use of price sensitivity scores may improve the efficiency of provider 102. For example, the process of vetting a prospect for a mortgage may be very time consuming and/or labor intensive for the provider 102. The provider may have to hire people to review paychecks, review past credit history, confirm the prospect has sufficient funds for closing or down payment, etc. If the provider could increase the take up rate using price sensitivity scores, then fewer man hours would be wasted vetting prospects who decide in the end not to take up a mortgage. Other efficiencies or improvements include better forecasting since the provider will be better able to tune offers to the price sensitivity of the prospects, thus increasing the take up rate and increasing the accuracy of forecasting.

Although FIG. 1 only shows a single prospect, a single third party database, and a single provider, any number of those elements may be included. For example, multiple providers may communicate with a price sensitivity scorer in order to obtain price sensitivity scores for their prospects. In another example, a given provider has multiple prospects and obtains price sensitivity scores for those prospects from a single price sensitivity scorer. In some other embodiments, there are multiple price sensitivity scorers in a system (e.g., to satisfy demand, address regional/national differences in price sensitivity, etc.)

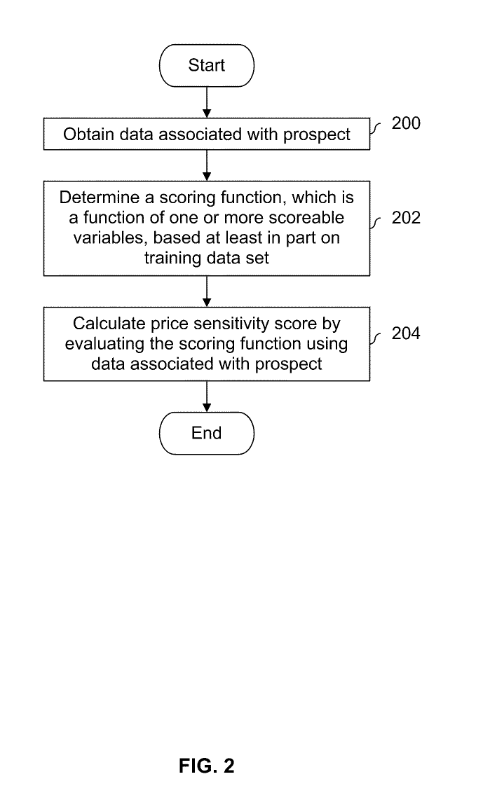

FIG. 2 is a flowchart illustrating an embodiment of a process for calculating a price sensitivity score. In some embodiments, the example process is performed by a processor or server which is accessed via a network (e.g., by price sensitivity scorer 104 in FIG. 1). In some embodiments, the example process is triggered when a provider initiates the process (e.g., provider 102 in FIG. 1 contacts price sensitivity scorer 104 and starts the process).

At 200, data associated with a prospect is obtained. For example, in FIG. 1, prospect data is given by prospect 100 to provider 102 and in some embodiments that information is passed on from provider 102 to price sensitivity scorer 104. In some embodiments, prospect data from one or more third party databases (e.g., a credit bureau or other information clearing house) is obtained. In some embodiments, prospect data is at the account level (e.g., how long a credit card has been open, the credit limit for that account, account usage such as credit usage to credit limit ratio, etc.). In some embodiments, prospect data is at the transaction level (e.g., a specific purchase, the purchase amount, the date purchased, the channel (e.g., in store, online, etc.).

At 202, a scoring function which is a function of one or more scoreable variables is determined based at least in part on a training data set. As used herein, a training data set is a set of data which is used to generate a scoring function. In some embodiments, a training data set includes historic transactions or (more generally) historic information. Some of the pieces of information in the training data set may be inputs to a scoring function; these are referred to as scoreable variables. In general, the most recent values of the scoreable variables are used to evaluate the scoring function at step 204. The scoring function itself is generated using historic information at step 202 which may or may not include the most recent values of the scoreable variables. In some embodiments, scoreable variables include a number of trade lines, a number of inquiries (e.g., in the last 3 months), and/or a number of trades past due (e.g., in the last 30 days). Other pieces of information in the training data set which are used to generate the scoring function but which are not inputs to the scoring function are referred to as non-scoreable variables.

In some cases, using information from a credit bureau and/or an application as a scoreable variable is desirable since this information is readily available for most prospects. It would not be very useful, for example, to have scoreable variables which cannot be easily obtained for some prospects since then it would be difficult or impossible to calculate a price sensitivity score for those people. Selecting readily available scoreable variables ensures a price sensitivity score can be generated for most prospects.

In some applications, it is desirable to use non-scoreable variables in generating a scoring function. For example, this may ensure that the scoring function produces price sensitivity scores which are statistically accurate. More specifically, using non-scoreable variables may provide context on the scoreable variables, when generating the scoring function, (i.e., when quantifying the effect of the scoreable variables on price sensitivity). Certain transactions (or, more generally, pieces of information in a training data set), have different intrinsic take ups. Home equity lines of credit for example may have relatively high take up percentages (e.g., 60% of all HELOC transactions are taken up) compared to credit card offerings (e.g., less than 5% of all credit card offers are accepted). Using non-scoreable variables in the process of determining a scoring function allows this type of context to be taken into account. Similarly, one channel (e.g., a branch) may tend to have a higher take up compared to another channel (e.g., Internet) and this can also be taken into account. For example, even though a certain prospect (referred to as prospect A) may, in general, be more price sensitive than another prospect (referred to as prospect B), prospect A's probability of taking up a home equity line of credit at a 10% APR may be higher than prospect B's probability of taking up a credit card at a 5% APR. If the context of these transactions (i.e., the financial products being offered) were unknown, prospect A may appear less price sensitive than prospect B, which would be incorrect and therefore which would yield an inaccurate price sensitivity scoring function.

In some embodiments, determining a scoring function at step 202 includes constraining the scoring function to generate price sensitivity scores that fall within a desired range. This is sometimes referred to as “grooming.” In one example, it may be desirable to have certain types of scores, a certain range of scores, and/or a certain distribution of scores. Grooming may address some of these objects to produce desirable scores. As an example of types of scores, integer values and/or positive numbers may be desirable as opposed to fractional or decimal scores (e.g., 1½ or 1.5) or negative scores (e.g., −250). As an example of grooming to change a range of scores, an initial range of scores from [−25, 25] is mapped to [200, 600]. Grooming may also adjust how the prices sensitivity scores are distributed (e.g., so that the scores have a linear or geometric relationship as described above or so the distribution is a uniform distribution, Gaussian distribution, etc.). Alternatively, in some embodiments, the same distribution is maintained.

In some embodiments, determining a scoring function at step 202 includes determining what scoreable variables to use as inputs to the scoring function. For example, a variety of statistical techniques, combined with a training data set, may be used to determine which variables (from a set of considered or candidate scoreable variables) are the best predictors. In some embodiments, there may be a desired degree of accuracy or some other metric such as a desired level of concordance or a target Kolmogorov-Smirnov statistic that a scoring function should satisfy and scoreable variables are added as inputs to the scoring function from best predictors to least predictors until that metric is satisfied.

At 204, a price sensitivity score is calculated for a prospect by evaluating the price sensitivity function using the prospect data. For example, the values of the prospect for the scoreable variables are plugged into a scoring function to calculate a score. If one scoreable variable is (for example) a number of trade lines then the number of trade lines for that prospect is entered into the scoring function.

In some embodiments, the step of determining a scoring function at step 202 is performed as frequently or as infrequently as desired. For example, a scoring function may be calculated and kept for some period of time and during that time is used to calculate as many price sensitivity scores as is desired. In one example, every 3 months a new scoring function is calculated using a training data set (which may include new information) and during a 3 month period the same scoring function is used to generate price sensitivity scores. Updating a training data set and regenerating a scoring function may permit the scores to respond to changes in market and/or economic conditions (which may cause people to become more or less price sensitive). In general, it is not necessary to recalculate a new scoring function for each prospect.

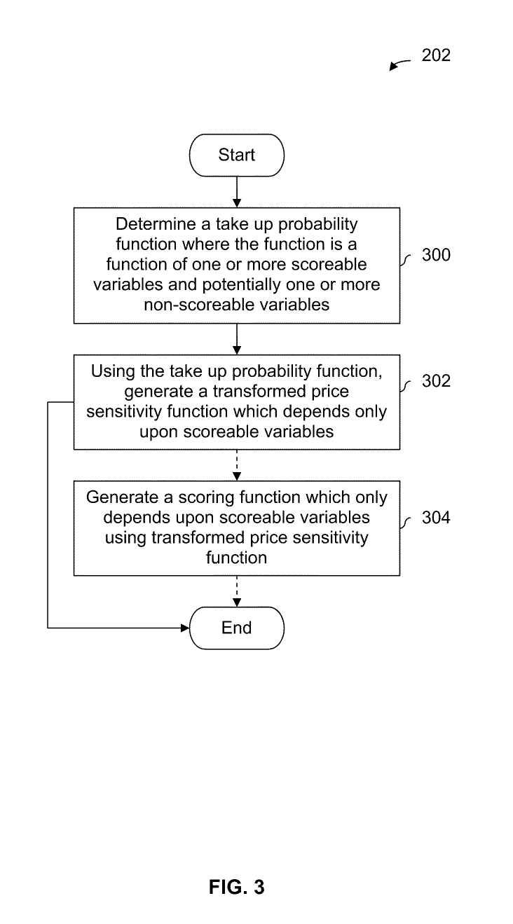

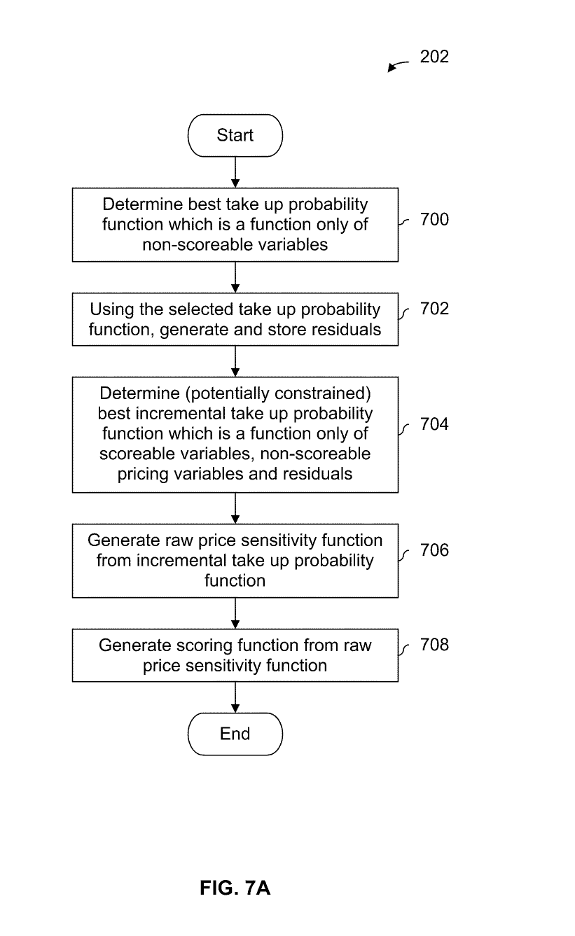

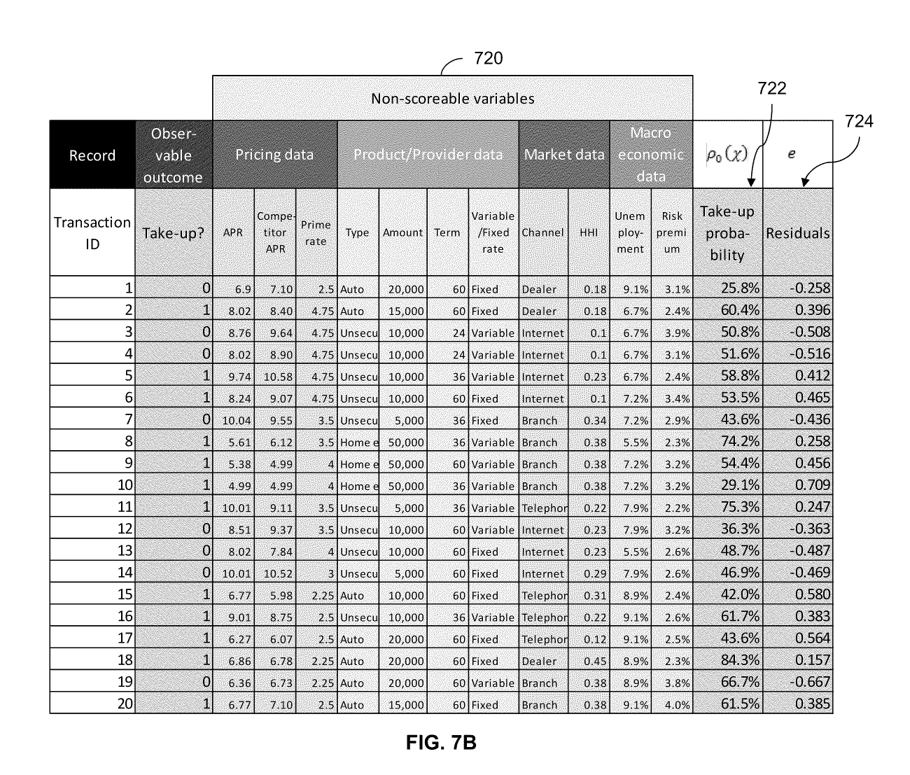

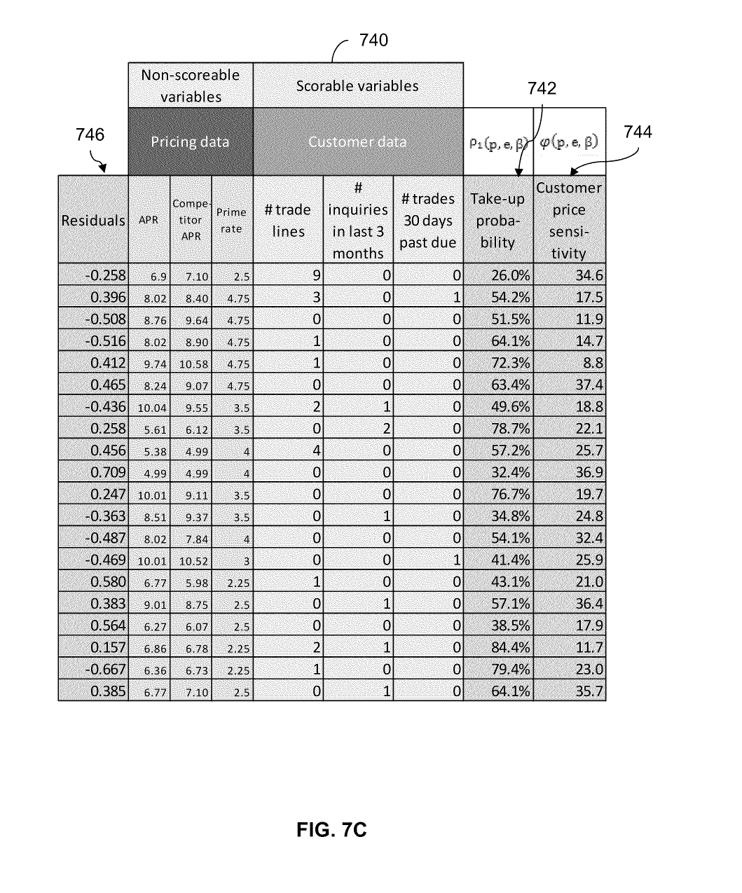

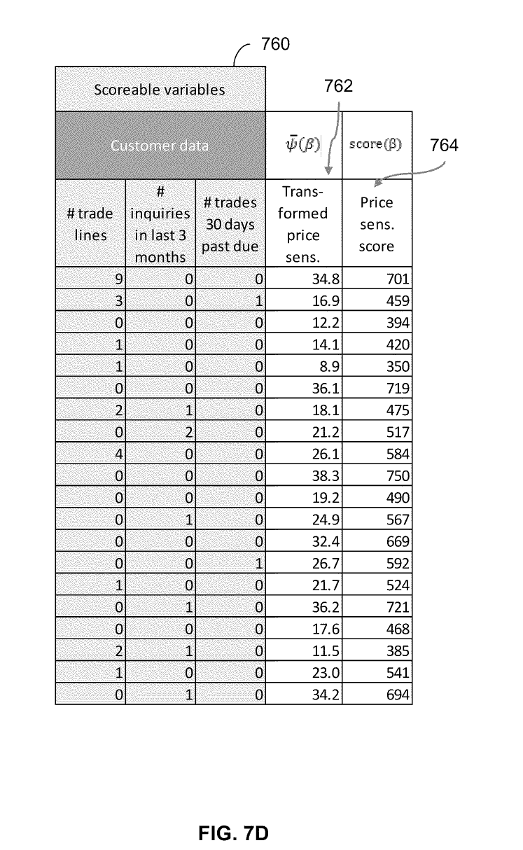

FIG. 3 is a flowchart illustrating an embodiment of a process for determining a price sensitivity function which is a function of one or more scoreable variables. In some embodiments, the example process shown herein is used in step 202 of FIG. 2. Some mathematical derivations used to generate the price sensitivity functions include a kernel technique, a decomposition technique and a residual technique; which are described in further detail. The example process shown in FIG. 3 is based, at a high level, on the kernel and the decomposition techniques, but not necessarily on the residual technique. The residual technique is illustrated in FIG. 7A.

At 300, a take up probability function is determined where the take up probability function is a function of one or more scoreable variables and potentially one or more non-scoreable variables. In some embodiments, price is a non-scoreable variable. In some embodiments, there are no non-scoreable variables used at step 300 (i.e., there are only scoreable variables). As described above, scoreable variables are inputs to the scoring function and are used to generate the scoring function, whereas non-scoreable variables are not inputs to the scoring function but are used in generating the scoring function.

At 300, a variety of techniques may be used to determine a take up probability function. In some embodiments, the process begins with a set of eligible or candidate take up functions. Using any appropriate technique (e.g., generalized linear models, generalized nonlinear models, etc.) the best candidate take up function is selected from the set and any parameters related to that take up probability function are determined. Binomial and Bernoulli regressions are two approaches used to fit generalized linear models. In some embodiments, the take up outcome will be continuous between 0 and 1 (for example, when it represents the utilization fraction for a line of credit; in this case, other non-linear regression approaches can be used for estimation).

A take up probability function is a probability function and therefore the output of the function ranges from 0 (i.e., it is absolutely certain that take up will not occur) to 1 (i.e., it is absolutely certain that take up will occur) and values between. Take up is defined as a prospect accepting an offer made by a provider and the take up probability function estimates or generates a probability that a take up will occur. For example, if the provider is a bank and a prospect is considering whether to open a CD, the take up probability function generates a probability (between 0 and 1) that the prospect will actually open a CD with the provider. At 300, a take up probability function is calibrated, on the training dataset, as a function of both non-scoreable and scoreable variables, and is therefore expressed as:

Pₜ₋ᵤₚ(χ/β)

where χ is a vector of one or more non-scoreable variables and β is a vector of one or more scoreable variables.

At 302, based on the calibrated take up probability function, a transformed price sensitivity function is derived which depends only upon scoreable variables. That is:

Pₜ₋ᵤₚ(χ,β) [symbol] ψ̅(β)

where ψ̅(β) is a transformed price sensitivity function which depends only upon scoreable variables. The mathematical transformation used to derive the transformed price sensitivity function from the calibrated take up probability function is described in further detail.

In some embodiments, the process ends at 302 and the transformed price sensitivity function ψ̅(β) is the scoring function score (β) without any further transformation or processing (i.e., score(β)= ψ̅(β). In some other embodiments, an optional step at 304 is performed where a scoring function is generated which only depends upon scoreable variables using a transformed price sensitivity function. For example:

ψ̅(β) [symbol] score(β).

In some embodiments, a scoring function is constrained to produce desirable scores that the raw values generated by the transformed price sensitivity function may not necessarily satisfy. For example, values generated by a transformed price sensitivity function may include decimals/fractions, negative values and such whereas the groomed values generated by a scoring function generated at 304 may (in some embodiments) be integers, be strictly positive, etc.

In general, a scoring function may be implemented in any form and/or using any data structure. In some embodiments, a scoring function is a mathematical equation in which one or more values for scoreable variables are entered and a value is output by the equation. In some other embodiments, there is some mapping between a first value and a second value. For example, the scoring function may include a lookup table or some other data structure which maps one value (e.g., transformed price sensitivity values) to another value (e.g., scores which are assigned to a prospect). In one example, there is a mathematical equation for a transformed price sensitivity function, ψ̅(β). The values of the scoreable variables are entered into the mathematical equation for ψ̅(β) and a transformed price sensitivity value is output. This value is then passed to a lookup table (or some other data structure) and the score which corresponds to that value is output. In yet another embodiment, there may be a multi-dimensional lookup table where the inputs are the values of the scoreable variables and the value returned is the price sensitivity score.

In some embodiments, the scoring function may be based on a utilization fraction (as, for example, the fraction of a line of credit that is utilized by a customer). In this case, the variable Pₜ₋ᵤₚ(χ,β) would represent the expected fraction of utilization rather than the probability of take-up.

In some embodiments, a training data set is used at 300 to determine a take up probability function and/or in conditioning the take up probability function at 302. In some embodiments, such a training data set includes data associated with a prospect for whom a price sensitivity score is currently being (or will be) calculated. In some embodiments, training data does not include data associated with a prospect currently being evaluated but includes data about other prospects and their historic behavior.

In some embodiments of the process described above, the transformation proceeds in one step (e.g., the decomposition technique). In some embodiments, the transformation proceeds in multiple steps (e.g., the kernel technique). In the later case, the calibrated take-up probability function is first used to derive a “raw” calibrated price sensitivity function (dependent upon both scoreable and non-scoreable variables) and this intermediary “raw” function is then used to derive a “transformed” price sensitivity function which is only dependent upon scoreable variables.

To more clearly illustrate the techniques, some specific examples using a specific training data set are described in further detail below. First, an exemplary training data set will be described. Then, using that exemplary training data set, a kernel technique, a decomposition technique and a residual technique are described.

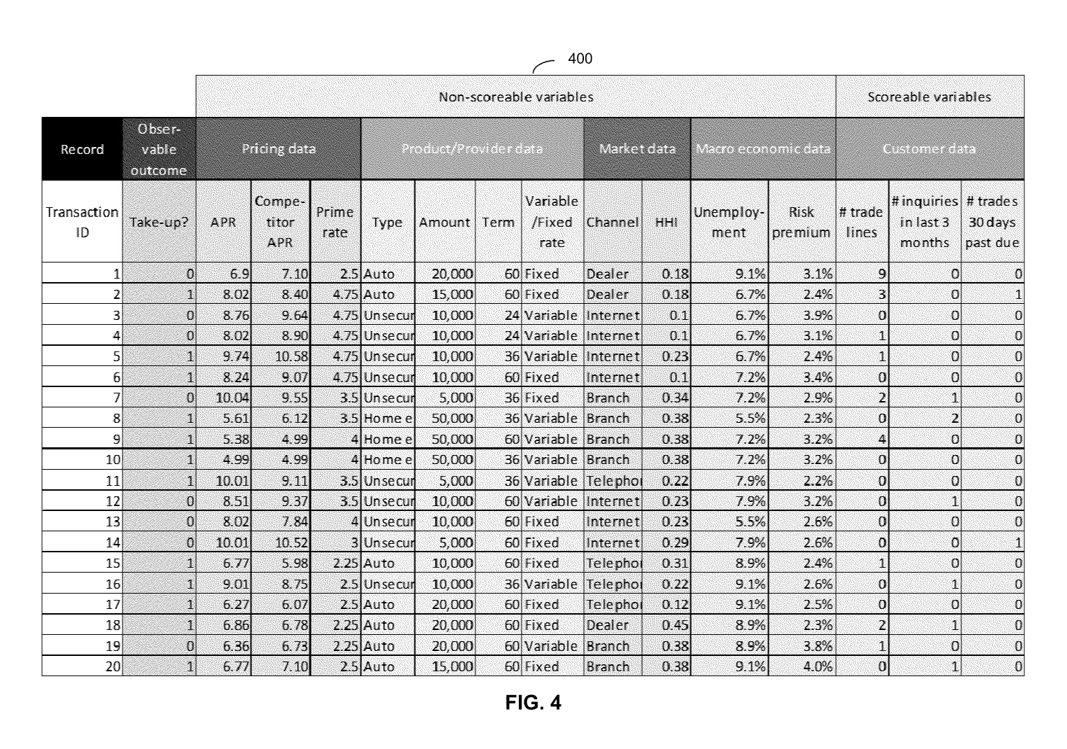

FIG. 4 is a diagram showing an embodiment of a training data set. In the example shown, the data set includes 20 records associated with any number of people. For clarity, only 20 records are shown but (e.g., for statistical reasons) the specific number of records used may be greater (e.g., on the order of thousands or hundreds of thousands).

Each record in training data set 400 includes a transaction ID, an observable outcome (e.g., whether that transaction was taken up or not), a set of non-scoreable variables and a set of scoreable variables. As described above, scoreable variables are used both to generate a scoring function and as arguments of such scoring function, whereas non-scoreable variables are only used to generate the scoring function.

In this example, the set of non-scoreable variables has four categories: pricing data, product/provider data, market data and macroeconomic data. Pricing data includes the price at which a transaction was approved (by the provider, for final approval by the prospect), competitor and market benchmark prices (specifically in this example: APR, competitor APR and prime rate). Product/provider data includes type (e.g., whether the transaction is associated with an auto loan, an unsecured loan, a home equity loan, etc.), an amount (e.g., in US dollars, Canadian dollars, etc.), a term or length (e.g., 60 months, 24 months, 30 years, etc.) and a rate type (e.g., whether the rate is variable or fixed or some combination thereof (e.g., a 5-year ARM). Market data may include (but is not limited to) channel (e.g., how the prospect came to or contacted the provider, for example by way of a dealer/broker, Internet/website, branch, telephone, etc.) and HHI. HHI (Herfindahl-Hirschman Index) is a measure of market concentration (e.g., how much or to what degree a market is monopolized); other measures of market concentration may be used. Macroeconomic data may include but is not limited to macroeconomic indicators describing the state of the market at the time of the transaction. In training data set 400, macroeconomic data includes unemployment (e.g., at the time the transaction occurred and/or at any level including local or state level such as unemployment rates in the state or metropolitan area in which the transaction occurred or the prospect resides) and credit or liquidity risk premium.

Customer data includes customer specific data (e.g., obtained from a credit bureau) and/or demographic data. In training data set 400, the set of scoring variables includes a number of trade lines, a number of inquiries (in this particular example, over the last 3 months) and a number of trades past due (in this example 30 days or more past due). In some embodiments, a set of scoring variables includes other information associated with a prospect including but not limited to: demographics (such as age, gender, income, homeowner versus renter and marital status) or other prospect data (such as an amount of debt or a debt to income ratio, any forgiven loans or debt (such as a write off or short sale), bankruptcies or age of credit or accounts (e.g., average age, age of newest, etc.)).

In some applications it is desirable for a training data set to include a wide variety of products, providers, prices, channels, etc. Including a wide variety of information (e.g., various products and prices) in the training data set ensures that the scoring function generated and the resulting scores are applicable or relevant across a wide range of applications (e.g., of prices and products). In other embodiments, only specific products, providers, prices, etc. are included in the training dataset so that the score generated for a prospect is only relevant in the context of these products, providers, prices, etc.

Next, some specific exemplary techniques of the creation of the scoring function are described in further detail. First, a kernel technique is described.

Kernel Technique

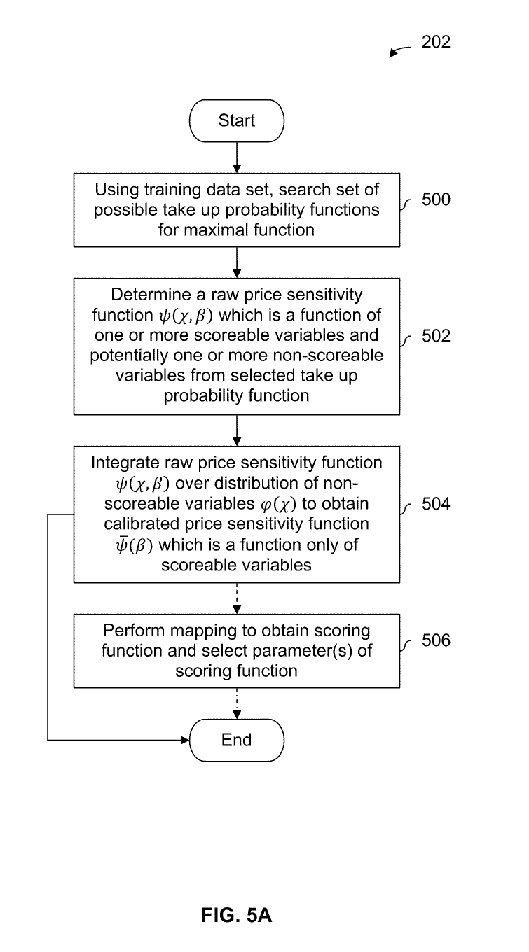

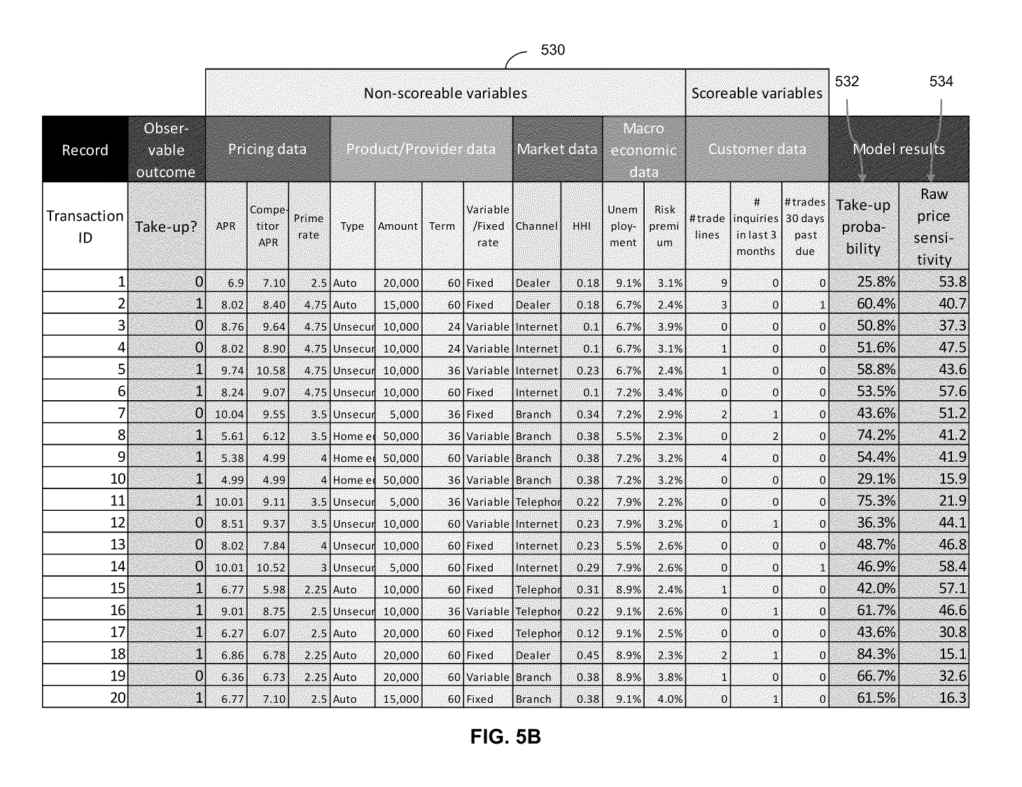

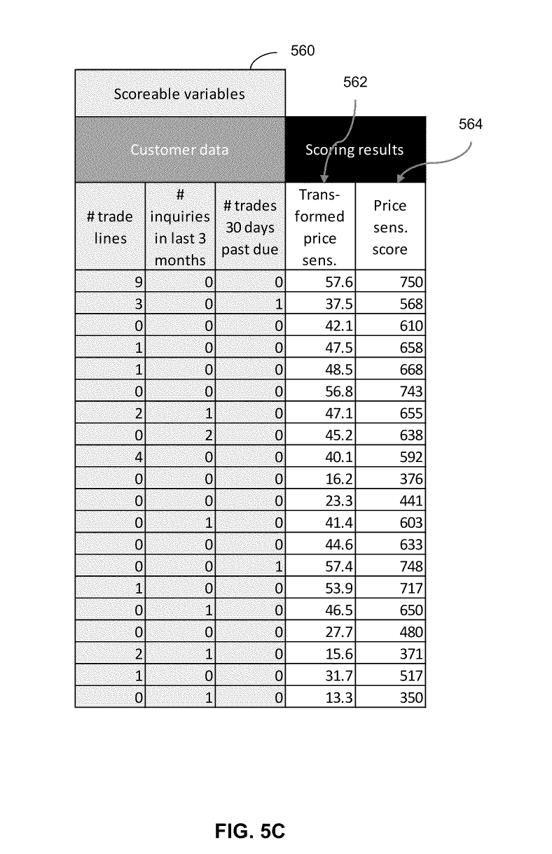

FIG. 5A is a flowchart illustrating an embodiment of a process for a kernel technique. In some embodiments, the example process is used to generate a scoring function at step 202 in FIG. 2.

At 500, a set of possible take up probability functions is searched using a training data set to find the function that has the most robust fit to the training data set (e.g., shown in FIG. 4). Each function may be examined, for example, and the function which best predicts the take up outcomes shown in FIG. 4 may be selected. Note that the training data set in FIG. 4 includes whether each transaction was actually taken up or not so each function can be “run” to obtain their predicted probability of take up which is then compared to the actual take up outcome observed.

In an example of step 500, let p denote the price of the loan, be χ be a vector of non-scoreable variables composed of price p and of all other non-scoreable variables θ; and let β be a vector of scoreable variables. The probability of take up Pₜ₋ᵤₚ is then expressed as a function of p, θ and β:

Pₜ₋ᵤₚ=ρ(p,θ,β).

in which the function ρ may (or may not) be constrained in a set of admissible functions. Example of admissible functions may be probability functions with non-positive partial derivative with respect to price. The function ρ is found in this example by maximizing the likelihood of the model over the set of admissible take up functions. The likelihood of the model is equal to

$$ℒ ( ρ ) = {\prod }_{i = 1}^{N} {ρ ( {p}_{i} , {θ}_{i} , {β}_{i} )}^{{1}_{\{ t - {up}_{i} = 1 \}}} {( 1 - ρ ( {p}_{i} , {θ}_{i} , {β}_{i} ) )}^{{1}_{\{ t - {up}_{i} = 0 \}}}$$

in which N is the number of records in the training data set, and 1_{{t-up=1}} is an indicator variable that takes the value 1 if t−up=1 and 0 otherwise and 1_{{t-up=0}}. Maximization of the likelihood function is sometimes referred to as maximum likelihood estimation.

In contrast to some other techniques (e.g. the decomposition technique, described below), the set of possible take up probability functions is not necessarily constrained, or at most is only weakly constrained. Some other techniques limit the set of eligible functions to stronger conditions or constraints.

In some embodiments, the set of possible take up probability functions used at 500 are parsimonious. By parsimonious, it is meant that the function should be able to predict take up using data outside of or in addition to the training data set (e.g., using a prospect's data when it comes times to actually calculate a price sensitivity score).

In some embodiments, the set of possible take up probability functions include one or more of the following: logit, probit, tobit, piece-wise affine or any other continuous, monotonic function on [0, 1].

At 502, a raw price sensitivity function ψ(χ,β), which is a function of one or more scoreable variables and potentially one or more non-scoreable variables, is determined from the selected take up probability function. Price sensitivity can be derived using a variety of metrics. In general, it is derived as:

$$ψ ( p , θ , β ) = \frac{\partial h ( ρ ( p , θ , β ) )}{\partial l ( p )} ,$$

in which h and l are increasing functions on the real line. Specific examples of price sensitivity metrics include the price elasticity:

$$ɛ ( p , θ , β ) = \frac{\partial ln ( ρ ( p , θ , β ) )}{\partial ln ( p )}$$

and the hazard rate:

$$κ ( p , θ , β ) = \frac{\partial ln ( ρ ( p , θ , β ) )}{\partial p} .$$

Regardless of the specific metric used, price sensitivity at this step is generated as a function of both scoreable and non-scoreable variables. See, e.g., above where ε and κ are both functions of non-scoreable variables p and θ as well as scoreable variables β.

At 504, a raw price sensitivity function ψ(χ, β) is integrated over a distribution of non-scoreable variables φ(χ) to obtain a transformed price sensitivity function ψ̅(β) which is a function only of scoreable variables. For example:

ψ̅(β)=∫ψ(χ,β)φ(ψ)dχ,

As described above, a price sensitivity function which is a function only of scoreable variables (but not non-scoreable variables) is referred to as a transformed price sensitivity function. Note that the resulting function ψ̅ is only a function of β and is not a function of χ. The resulting function at 504 may be considered an average since the function ψ(χ, β) is integrated over the distribution (χ).

In general, the distribution φ over which the integration is performed is a multivariate distribution (with as many variables as non-scoreable variables). However in some embodiments, the distribution φ is a one dimensional kernel function (for example when price is the only non-scoreable variable). Some example kernel functions which may be used are:

| Name | Form (as a function of χ and parameterized by p̅) |
|---|---|
| Uniform | (Δ/2)I_{[ p̅−Δ, p̅+Δ]} |
| Triangular | (1/Δ²)[Δ − sgn( p̅ − χ)( p̅ − χ)I_{[ p̅−Δ, p̅+Δ]} |
| Epanechnikov | (3/4Δ)[1 − (( p̅ − χ)/Δ)²]I_{[ p̅−Δ,} _{p̅}+Δ] |
| Gaussian | $( 1 / \sqrt{2 π} ) {e}^{\frac{- {( χ - \overline{p} )}^{2}}{2}} / Φ ( \overline{p} ) {I}_{[ 0 , ∞ ]}$ |

Table 1: Example of one dimensional kernel functions used in integrating price sensitivity function to eliminate non-scoreable variables (such as price. In which case, p̅ could reflect the average price in the market).

In the kernel functions in Table 2, I_{[ p̅−Δ, p̅+Δ]} is an indicator function where I_{[ p̅−Δ, p̅+Δ]}=1 for xε[ p̅−Δ, p̅+Δ] and I_{[ p̅−Δ, p̅+Δ]} otherwise.

In some embodiments, the process ends after step 504. In some other embodiments, step 506 is performed after step 504. At 506, a mapping is performed to obtain a scoring function. For example, in the case of an affine mapping between the transformed price sensitivity function and the scoring function:

score(β)=a ψ̅(β)+b

then a and b are selected so that the scores generated by score (β) are within a desired range (e.g., scores which are positive integers between 200 and 800). An affine mapping is a transformation or process which preserves co-linearity (i.e., points on a line continue to be on a line even after the transformation) and ratios of distances along a line are preserved. In some other embodiments, some other transformation or processing is used to go from a transformed price sensitivity function to a scoring function other than affine mapping.

The following figures show the process of FIG. 5A when applied to the example training data set of FIG. 4.

FIG. 5B is a diagram showing an embodiment of a training data set after a raw price sensitivity function (which is a function of both scoreable and non-scoreable variables) is determined using a kernel technique. In the example shown, steps 500 and 502 of FIG. 5A have been performed.

Column 532 shows a selected take up probability function (not shown and which is a function of both scoreable and non-scoreable variables) evaluated for each transaction (i.e., row). The take up probability function is selected at 500 in FIG. 5A.

Column 534 shows a raw price sensitivity function (not shown) evaluated for each transaction in data set 530. As described above, a raw price sensitivity function is function of both scoreable variables and non-scoreable variables, whereas a transformed price sensitivity function is only a function of scoreable variables (i.e., and not non-scoreable variables). A raw price sensitivity function (ψ) is determined at 504 in FIG. 5A.

FIG. 5C is a diagram showing an embodiment of a training data set after the kernel technique has been completed. In the example shown, the training data set shown in FIG. 4 is similarly used as a basis for the processing. At this point in the kernel technique, the functions of interest are only related to scoreable variables and so data set 560 shows the scoreable variables but not non-scoreable variables.

Column 562 in data set 560 shows a transformed price sensitivity function (not shown) evaluated for each transaction in data set 560. In FIG. 5A, the transformed price sensitivity function ( ψ̅) is generated at step 504.

Column 564 shows a scoring function (not shown) evaluated for all transactions in data set 560. In FIG. 5A, the scoring function is generated at 506. Note that although the values in column 562 include decimals and negative values, the values shown in column 564 have been groomed so that they are positive and real integers. It may be desirable in some applications to have groomed scores which are within a certain desired range, are positive integers, etc.

Next, a decomposition technique is described in further detail.

Decomposition Technique

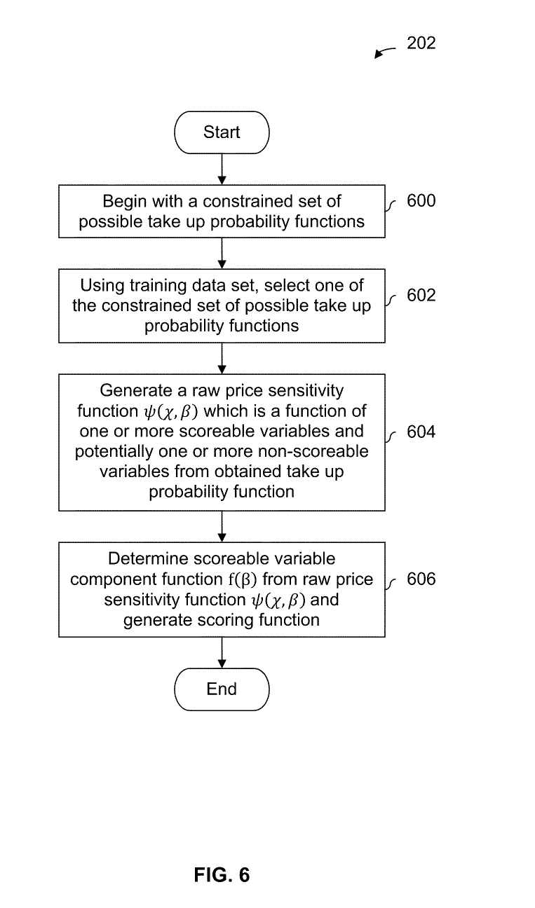

FIG. 6 is a flowchart illustrating an embodiment of a process in which a decomposition technique is performed. In some embodiments, the example process is used to generate a scoring function at step 202 in FIG. 2.

At 600, the technique begins with a constrained set of possible take up probability functions. The decomposition technique (e.g., unlike the kernel technique) restricts the possible take up probability function to certain functions which satisfy certain constraints. In some embodiments, one or more of the following conditions must be satisfied:

Condition 1: a candidate raw price sensitivity function ψ(χ,β) (which is derived from the take up probability function) must be able to decompose into a scoreable component and a non-scoreable component:

ψ(χ,β)=h(ƒ(β),g(χ))

in which ƒ and g are multivariate functions valued on the real line and in which h is a real valued function, increasing in its first argument (so that for all values of the non-scoreable variables, the ordering of prospects price sensitivity will be determined by ƒ(β). In some embodiments, ψ(χ,β) might be additively separable in which case ψ(χ, β)=ƒ(β)+g(χ). In other embodiments, ψ(χ, β) might be multiplicatively separable, in which case, ψ(χ, β)=ƒ(β)g(χ).

A variety of metrics can be used as the raw price sensitivity function (such as the price elasticity ε(p, θ, β) and the hazard rate κ(p, θ, β) described above) which is derived from the take up function ρ(p, θ, β). However, whatever specific metric is used must be decomposable into a first function of just scoreable variables (e.g., ƒ(β) and a second function of just non-scoreable variables (e.g., g(χ)). For example, it may decompose into a sum or a product of two separate functions of just scoreable and respectively non-scoreable variables.

Condition 2: If there exists a decomposed raw price sensitivity function ψ(χ, β), there must be an equivalence between ψ(χ, β) and price elasticity ε(χ, β). That is, for some region X of χ (which will be specified further), and for all β₁ and β₂:

if χ(χ,β₁)>ψ(χ,β₂), then ε(χ,β₁)>ε(χ,β₂).

That is, in the region X of χ (i.e. for some set of non-scoreable variables), an eligible raw price sensitivity function ψ(χ, β) and the price elasticity ε(χ, β) of a take up probability function will order prospects in the same order. Finally the set X of non-scoreable variables in which the equivalence holds should reflect typical market conditions (e.g. should include typical products and typical market prices).

At 604, a raw price sensitivity function ψ(χ, β) is generated which is a function of one or more scoreable variables and one or more non-scoreable variables from the obtained take up probability function. As described above, the considered take up probability functions (and thus the resulting raw price sensitivity function) are limited to those functions which satisfy certain condition(s).

At 606, a scoreable variable component function ƒ(β) is determined from a raw price sensitivity function ψ(χ, β) and a scoring function is generated. For example, if the two conditions above are applied, the ordering of prospects using the raw price sensitivity ψ(χ, β) is invariant across any values of the non-scoreable variables and is determined by the scoreable variable component function ƒ(β). This function, which represents the customer marginal price sensitivity, is therefore directly used to generate the scoring function using a mapping (described above). In the case of an affine mapping:

score(β)=aƒ(β)+b

As described above, the parameters a and b may be selected so that the scoring function is constrained to some desired range of price sensitivity scores.

Next, a residual technique is described in further detail. In the example described below, the technique does not necessarily use the exact information shown in training data set 400 in FIG. 4. The example below describes how residuals (generated from the information in training data set 400) are used in the process.

Residual Technique

FIG. 7A is a flowchart illustrating an embodiment of a process for performing a residual technique. In some embodiments, the example process is used to generate a scoring function at step 202 in FIG. 2.

At 700, a best take up probability function which is a function only of non-scoreable variables is determined. Using the selected take up probability function, residuals (i.e. model errors), are generated and stored at 702. As described above, the residual technique does not use the data shown in training data set 400 precisely, but rather residuals which are derived from it. Steps 700 and 702 therefore generate these residuals from a training data set; the residuals are then stored, and some other information, no longer needed, can be deleted. Information which can be deleted at the end of step 702 is specified in further detail.

In some embodiments, raw price sensitivity estimates are also generated and stored with the residuals at 702. These raw price sensitivity estimates are based on the model of 700, and therefore only depend on the non scoreable variables. They are referred to as non scoreable variable specific price sensitivity estimates and are denoted as ψ̅.

As an example of step 700, the take up probability function is expressed as:

Pₜ₋ᵤₚ=ρ₀(χ)

and the selection of the best take up function is performed using, for example, standard system identification techniques.

Once the best take up probability is determined, one or more types of residuals are determined at 702. In some embodiments, a type of residual is:

e=1_{{t-up=1}}−Pₜ₋ᵤₚ

which is the difference between the actual take-up and the predicted take-up probability and is calculated for each transaction.

In some embodiments, some information associated with training data set 400 shown in FIG. 4 is not needed after step 702 is completed. In some embodiments, some or all of this information which is no longer needed is discarded after step 702. Some examples of information which may be discarded include product/provider information. Some other examples include subsets of the pricing information. In some embodiments, all pricing variables are stored (including the non scoreable variable specific price sensitivity estimates) and none are deleted; in other embodiments, only some derivatives of the pricing variables (e.g. price minus average market price or price minus best competitor price) are stored, and the rest are deleted.

At 704, a best incremental take up probability function which is a function only of scoreable variables, non-scoreable pricing variables and residuals is determined. The take up probability function at step 700 and 704 are functions of different variables (i.e., of non-scoreable variables in the case of step 700 and of scoreable variables, non-scoreable pricing variables and residuals in the case of step 704). Let ρ₁ denote the resulting incremental take up probability function:

Pₜ₋ᵤₚ=ρ₁(π,e,β),

in which π represents a vector of non-scoreable pricing variables, which may include, for example, price p and non-scoreable variable specific price sensitivity estimates, ψ̅.

A raw price sensitivity function is generated from incremental take up probability function at 706 and a scoring function is generated from the raw price sensitivity function at 708.

In a first embodiment of steps 704-708, no particular structure or conditions are enforced regarding the space of permitted functions β₁ and kernel technique described above can be used to obtain a transformed price sensitivity function ψ̅(β) which is only dependent on scoreable variables. In a second embodiment of steps 704-708, the decomposition technique is used where one or more conditions on candidate functions are enforced.

The following figures show the training data set of FIG. 4 when the process of FIG. 7A is applied.

FIG. 7B is a diagram showing an embodiment of training data set after a take up probability function is selected and residuals are generated in a residual technique. In the example shown, steps 700 and 702 in FIG. 7A have been performed. At this point in the processing, the scoreable variables are not used and therefore data set 720 does not include the scoreable variables from FIG. 4.

Column 722 of data set 720 shows the take up probability which results when the non-scoreable variables for each transaction are entered into ρ₀(χ). Column 724 shows the residuals generated, which in this example is the difference between the actual take up and the modeled take up probability. Using transaction ID 1 as an example, a value of −0.258 is obtained because it is the difference between the observable outcome, equal to 0, and the take up probability, equal to 0.258 (i.e., 0−0.258=−0.258). Similarly, for transaction ID 2, the value is 0.396 because 1−0.604 results in 0.396.

FIG. 7C is a diagram showing an embodiment of a data set after a best incremental take up probability function is determined in a residual technique. In the example shown, steps 704 and 706 shown in FIG. 7A have been performed. At this point in the process, the relevant function(s) (e.g., the incremental take up probability function) are functions only of scoreable variables, non-scoreable pricing variables and residuals. Correspondingly, data set 740 only shows residuals (column 746), non-scoreable pricing variables and scoreable variables.

Column 742 shows the take up probability calculated using the function ρ₁. ρ₁ is a function of pricing variables (p), residuals (e) and scoreable variables (β) so those values for each of the transactions is entered into the function to obtain the values shown in column 742. The β₁ function is determined at step 704.

Column 744 shows price sensitivity which is calculated using the raw price sensitivity function derived from the take up function ρ₁. Similarly, this raw price sensitivity function is a function of the pricing variables (π), residuals (e) and scoreable variables (β) and those values are input into the function to obtain the values shown in column 744.

FIG. 7D is a diagram showing an embodiment of a data set after a scoring function is determined in a residual technique. At this point in the process, step 708 in FIG. 7A has been performed. Since the relevant function(s) at this point (i.e., the scoring function) is only a function of scoreable variables, only the scoreable variables are shown in data set 760.

Column 762 shows the values of the transformed price sensitivity function ψ̅(β). Column 764 shows the scores generated using the function score(β). For each of the transactions, the corresponding scoreable variables are entered and the resulting values are shown in columns 762 and 764. As described above, a variety of techniques (e.g., the kernel technique or the decomposition technique) may be used to obtain the transformed price sensitivity function ψ̅(β) and the scoring function score(β).

In some embodiments, the process of generating a scoring function varies from the examples shown herein. In some embodiments, certain steps (e.g., shown in FIG. 3, 5A, 6 or 7A) are skipped and/or are combined together. In some embodiments, the process of generating a scoring function goes directly from a take up probability function to a scoring function without (for example) generating any intermediate functions (e.g., raw/transformed price sensitivity functions). Alternatively, other intermediate functions besides those shown herein may be generated.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for calculating a price sensitivity score for a prospect, comprising:
obtaining data associated with a prospect;
using a processor to determine a scoring function, which is a function of one or more scoreable variables, based at least in part on training data set; and
calculating a price sensitivity score by evaluating the scoring function using the data associated with the prospect.

2. The method of claim 1, wherein using the processor to determine the scoring function includes using said one or more scoreable variables and potentially one or more non-scoreable variables.

3. The method of claim 1, wherein using the processor to determine the scoring function includes constraining the scoring function to only generate price sensitivity scores that fall within a desired range of price sensitivity scores.

4. The method of claim 3, wherein the price sensitivity scores have a linear relationship with respect to each other.

5. The method of claim 3, wherein the price sensitivity scores have a geometric relationship with respect to each other.

6. The method of claim 3, wherein the price sensitivity scores order prospects in terms of price sensitivity.

7. The method of claim 1, wherein using the processor to determine the scoring function includes:
determining a take up probability function, wherein the take up probability function is a function of one or more scoreable variables and potentially one or more non-scoreable variables; and
using the take up probability function, generate a transformed price sensitivity function which depends only upon one or more scoreable variables.

8. The method of claim 7, wherein using the processor to determine the scoring function further includes generating a scoring function which only depends upon one or more scoreable variables using the transformed price sensitivity function.

9. The method of claim 1, wherein using the processor to determine the scoring function includes:
determining a raw price sensitivity function, which is a function of one or more scoreable variables and potentially one or more non-scoreable variables, using a take up probability function which is a function of one or more scoreable variables and potentially one or more non-scoreable variables; and
integrating the raw price sensitivity function over a distribution of non-scoreable variables to obtain a transformed price sensitivity function which is a function only of one or more scoreable variables.

10. The method of claim 1, wherein using the processor to determine the scoring function includes using a constrained set of possible functions, including the following constraints:
(1): a candidate raw price sensitivity function ψ(χ, β) must be able to decompose into:
ψ(χ,β)=h(ƒ(χ),g(β)); and/or
(2): For some non-scoreable variables χ and for all scoreable variables β₁ and β₂ if ψ(χ, β₁)>ψ(χ, β₂), then ε(χ, β₁)>ε(χ, β₂), where ε is a price elasticity function.

11. The method of claim 1, wherein using the processor to determine the scoring function includes:
determining a best take up probability function based only on one or more non-scoreable variables;
using the best take up probability function to generate and store one or more types of residuals;
determining a best incremental take up probability function which is a function of one or more residuals, one or more non-scoreable pricing variables and one or more scoreable variables; and
determining a price sensitivity scoring function which is only a function of the scoreable variables based at least in part on the best incremental take up probability function.

12. The method of claim 11, wherein the best incremental take up probability function includes a constrained function.

13. The method of claim 11, wherein the one or more types of residuals include a take up error associated with a historic transaction, wherein the take up error is calculated using the best take up probability function and a known take up outcome associated with the historic transaction.

14. A system for calculating a price sensitivity score for a prospect, comprising:
a processor; and
a memory coupled with the processor, wherein the memory is configured to provide the processor with instructions which when executed cause the processor to:
obtain data associated with a prospect;
determine a scoring function, which is a function of one or more scoreable variables, based at least in part on training data set; and
calculate a price sensitivity score by evaluating the scoring function using the data associated with the prospect.

15. The system of claim 14, wherein determining the scoring function includes using said one or more scoreable variables and potentially one or more non-scoreable variables.

16. The system of claim 14, wherein determining the scoring function includes constraining the scoring function to only generate price sensitivity scores that fall within a desired range of price sensitivity scores.

17. The system of claim 14, wherein determining the scoring function includes:
determining a take up probability function, wherein the take up probability function is a function of one or more scoreable variables and potentially one or more non-scoreable variables; and
using the take up probability function, generate a transformed price sensitivity function which depends only upon one or more scoreable variables.

18. The system of claim 17, wherein determining the scoring function further includes generating a scoring function which only depends upon one or more scoreable variables using the transformed price sensitivity function.

19. The system of claim 14, wherein determining the scoring function includes:
determining a raw price sensitivity function, which is a function of one or more scoreable variables and potentially one or more non-scoreable variables, using a take up probability function which is a function of one or more scoreable variables and potentially one or more non-scoreable variables; and
integrating the raw price sensitivity function over a distribution of non-scoreable variables to obtain a transformed price sensitivity function which is a function only of one or more scoreable variables.

20. The system of claim 14, wherein determining the scoring function includes using a constrained set of possible functions, including the following constraints:
(1): a candidate raw price sensitivity function ψ(χ, β) must be able to decompose into:
ψ(χ,β)=h(ƒ(χ),g(β)); and/or
(2): For some non-scoreable variables χ and for all scoreable variables β₁ and β₂ if ψ(χ, β₁)>ψ(χ, β₂), then ε(χ, β₁)>ε(χ, β₂), where ε is a price elasticity function.

21. The system of claim 14, wherein determining the scoring function includes:
determining a best take up probability function based only on one or more non-scoreable variables;
using the best take up probability function to generate and store one or more types of residuals;
determining a best incremental take up probability function which is a function of one or more residuals, one or more non-scoreable pricing variables and one or more scoreable variables; and
determining a price sensitivity scoring function which is only a function of the scoreable variables based at least in part on the best incremental take up probability function.

22. The system of claim 21, wherein the best incremental take up probability function includes a constrained function.

23. The system of claim 21, wherein the one or more types of residuals include a take up error associated with a historic transaction, wherein the take up error is calculated using the best take up probability function and a known take up outcome associated with the historic transaction.

24. A computer program product for calculating a price sensitivity score for an prospect, the computer program product being embodied in a computer readable storage medium and comprising computer instructions for:
obtaining data associated with a prospect;
determining a scoring function, which is a function of one or more scoreable variables, based at least in part on training data set; and
calculating a price sensitivity score by evaluating the scoring function using the data associated with the prospect.
